(19) United States
(12) Patent Application Publication
(10) Pub. No.: US 2003/0014339 A1
(43) Pub. Date: Jan. 16, 2003

(54) Cash flow management system and method

(76) Inventors: Joel L. Bush, Austin, TX (US); Jeffery D. Sewell, Austin, TX (US)

Correspondence Address: Mollie Hamel, Conley, Rose & Tayon, P.C., P.O. Box 398, Austin, TX, 78767, US

(21) Appl. No.: 09/906,592

(22) Filed: Jul. 16, 2001

(51) Int. Cl. G06F 17/60

(52) U.S. Cl. 705/35

(57) ABSTRACT

A method and a system are provided for managing a cash flow stream. In particular, a method is provided for managing a merchant's flow of income. Such a method includes accessing sales information of the merchant through an Internet connection adapted for control independent of the merchant. The method further includes calculating a cash flow from a sales transaction by the merchant and distributing a portion of the cash flow to a recipient. Preferably, the portion of the cash flow distributed to the recipient may be calculated from distribution guidelines specified by the merchant. A computer-readable medium adapted to execute such a method is also provided. In addition, a cash flow management system and a method for creating such a system are also provided.

### BACKGROUND OF THE INVENTION

1. Field of the Invention

This invention relates to business management applications, and more particularly, to an improved method and system for managing cash flow.

2. Description of the Related Art

The following descriptions and examples are not admitted to be prior art by virtue of their inclusion within this section.

Managing a business may include several facets, particularly ones requiring organization and detailed attention. For example, some of the more important facets of managing a business may include chartering resources, negotiating contract terms, and managing financial details. In addition, product development and marketing may also play an important role. However, any one or combination of these facets may take a considerable amount of time and energy to manage. Consequently, the lack of time and/or lack of resources may limit a merchant from fully marketing and selling their product. This may be particularly true for merchants who are, perhaps, just starting their own business. In general, the term “merchant” may refer to one who offers products for sale. Such products may include goods, services, or entertainment.

Occasionally, merchants may contract out certain facets of their business in order to, for example, aid in the development or enhance the marketability of their products. For instance, a musician may contract a designer to design a CD cover. Likewise, a storeowner may contract a printer to print advertisements. In some cases, a merchant may hire an individual or entity to manage the financial aspects of their business. However, employing an individual or entity to manage the financial aspects of a business may not allow a merchant to have access or full control of that part of their business. For example, a merchant may not be able to access or modify allocations of a cash flow stream generated from the sales of his/her products. In addition to limiting a merchant's access and control of their business, contracting a financial manager may be very costly. This may be particularly true for a merchant with limited monetary resources. So, often merchants are faced with the task of managing the financial aspects of their business on their own. As stated above, such a task may limit merchants from selling and marketing their products to their full potential.

In an effort to increase sales and awareness of their products, some merchants contract their entire business to large management companies. For example, a musician may contract a large record company in order to market their name and songs to a larger audience. As a result, they may be able to sell more of their work and consequently generate more income. Unfortunately, contracts with such large entities generally exclude merchants from having control of how their business is handled. For example, merchants contracting their business with a large management company may not have control of how their products are marketed or even which products are offered for sale. In addition, merchants may not have control of choosing and negotiating contracts with support personnel and suppliers. Support personnel and suppliers may refer to any individual or entity that may aid or support the development, production, and marketing of a merchant's products. For example, support personnel and suppliers may include printers, designers, recorders, and raw material suppliers.

Furthermore, a large entity generally manages the cash flow stream generated by the sale of a merchant's products. Such management may include collecting proceeds from the product sales and allocating portions of the cash flow to different entities, such as support personnel, suppliers, and the merchant. Since the merchant is designated to receive an allocated portion of the cash flow as any other contracted entity, the merchant typically does not have control as to where the other allocations are spent. In this manner, the merchant is essentially another contracted entity of the large management company rather than an owner and manager of his/her own business. In addition, the flexibility of a merchant's product, in such an embodiment, is limited since the marketing and development decisions regarding the product are managed by the large entity. As such, the merchant's influence regarding the direction and overall layout of the product is diminished or eliminated. Furthermore, contracting a business with a large management company is very difficult to accomplish. Very few merchants get the chance to sign with a large management company due to stiff competition and the limited number of opportunities.

Therefore, it would be desirable to create a cash flow management system and method which enables a merchant to access and control the financial aspects of their business while reducing the amount of time it takes to manage such a task. In particular, it would be desirable to create a cash flow management system that automatically calculates and allocates portions of a cash flow stream according to guidelines set by the merchant. Such a system and method may allow a merchant to concentrate on aspects of the business that pertain more to their interests, while allowing the merchant to have control of the financial aspects of their business at all times.

### SUMMARY OF THE INVENTION

The problems outlined above may be in large part addressed by a method for managing a cash flow stream. In particular, a method is provided which includes accessing sales information of a merchant through an Internet connection. The Internet connection is preferably adapted for control independent of the merchant. In this manner, the accessing step may include accessing sales information over an Internet connection by a user separate from the merchant. In addition or alternatively, the accessing step may include accessing sales information over an Internet connection by the merchant.

The method may further include receiving a sales transaction from the accessed sales information. Generally, the sales transaction may be obtained from a sale of a product sold by the merchant. Such a product may include goods, services, or entertainment. In particular, goods may include physical products such as books, CD's, or works of art. In addition, good may include digital products such as mp3 files or e-books. The receipt of the sales transaction may involve downloading the sales transaction from an Internet store maintained by the merchant. An “Internet store” may be referred to as any Internet display from which products are offered for sale. For example, the Internet store may be part of a “host” website, i.e. a website that offers a plurality of Internet stores within one website. Alternatively, the Internet store may be a website by itself. In another embodiment, the sales transaction may be received from an inventory control system. In addition, the method may include calculating a cash flow from the received sales transaction and distributing a portion of the cash flow to a recipient. In an embodiment in which the sales information of the merchant was accessed by an independent user, distributing the portion of the cash flow may include forwarding the portion of the cash flow through the user to the recipient. In another embodiment, the method may include determining the portion of the cash flow from distribution parameters set by the merchant.

A cash flow management system using the method as described above is provided. The cash flow management system may include a means for accessing sales information of sales of a merchant through an Internet connection. Such an accessing means may be adapted such that the sales information may be accessed independent of the merchant. The method may further include a means for receiving a sale from the accessed sales information and a calculating means for computing a cash flow from the received sale. In addition, the method may include a payment means for paying a portion of said cash flow to a recipient. In some embodiments, the system may include a database in addition to a means for recording the sale into the database. The database may include a list of products offered for sale by the merchant and the number of products sold for a specific period of time. Such products may include goods, services, or entertainment. In particular, goods may include physical products such as books, CD's, or works of art. In addition, good may include digital products such as mp3 files or e-books. In addition or alternatively, the database may include a list of recipients and distribution guidelines associated with each recipient. In some embodiments, the calculating means may be adapted to calculate the portion of the cash flow to be paid to the recipient based on the distribution guidelines.

A computer-readable medium is also contemplated herein which includes program instructions to execute the method described above. More specifically, the computer-readable medium may include a program for accessing a sales tracking device governed by a merchant. The access program is preferably adapted such that access is conducted independent of the merchant through an Internet connection. In some embodiments, however, the accessing program may be adapted such that the merchant may also access the sales tracking device. The computer-readable medium may further include a database for receiving information about a sale from the accessed sales tracking device. In addition, the computer-readable medium may include a program for calculating a cash flow attributable to the received sale. A program for distributing a payment corresponding to at least a portion of the calculated cash flow may also be included in the computer-readable medium. Such a payment may be distributed to a recipient designated by the merchant. In some embodiments, the distribution program may be adapted to transfer the payment electronically. However, other methods of distribution may be used. In some cases, the portion of the cash flow distributed may be a percentage of the cash flow calculated by the distribution program. The percentage may be a fixed or a variable amount depending on inputs to the distribution program. In some embodiments, the payment may include a monetary or security interest.

A method for creating a cash flow management system is provided. The method may include registering a user with a central management system. In a preferred embodiment, the user may offer products for sale via an Internet store controlled by the user. In some embodiments, the Internet store may be created independent of the central management system. The method may further include targeting a recipient to receive a portion of a cash flow generated from sales of the products. Targeting a recipient may include, for example, selecting a contractor to help the user market or sell their products. In a preferred embodiment, targeting the recipient may be by the user. In addition, the method may include setting rules on how the portion of the cash flow is to be distributed to the recipient. Preferably, the user has input to such rules. In some embodiments, setting rules may include designating at least one payment variable, such as a percentage or a fixed monetary amount. In addition, setting rules may include designating a respective qualifying variable for each payment variable. Examples of such qualifying variables may include a period of time, an aggregate cash flow amount, or the number of products sold by the user. In addition or alternatively, setting rules may include designating a segment of the cash flow from which to calculate the portion of the cash flow distributed to the recipient.

In a preferred embodiment, the central management system may be adapted to receive the cash flow on behalf of the user. As such, the central management system may be further adapted, in some cases, to forward the portion of the cash flow to the recipient according to the distribution rules set by the user. In some embodiments, the central management system may be adapted to delay forwarding the portion of the cash flow to the recipient. For example, the central management system may be adapted to delay forwarding the portion of the cash flow beyond a time relative to which the cash flow is received. Alternatively, the central management system may be adapted to immediately forward the portion of the cash flow relative to a time at which the cash flow is received.

There are several advantages associated with the systems and methods as described herein. For example, a merchant may have control of his/her business. More specifically, a merchant may have control of how their product is sold, marketed, and developed. Another advantage of the presently claimed cash flow management systems and methods is ability of a merchant to set guidelines with regard to how incoming cash flow is distributed. In addition, merchants do not have to actually trouble themselves with the physical task of calculating and forwarding payments to recipients. The systems and methods as described herein may advantageously access sales information of a merchant independently of the merchant and automatically calculate distribution payments based on guidelines set by the merchant.

### BRIEF DESCRIPTION OF THE DRAWINGS

Other objects and advantages of the invention will become apparent upon reading the following detailed description and upon reference to the accompanying drawings in which:

FIG. 1 depicts a flowchart of a method for managing a cash flow stream;

FIG. 2 depicts a computer-readable medium adapted to manage a cash flow stream;

FIG. 3 depicts a flowchart of a method for creating a cash flow management system;

FIG. 4 depicts a cash flow management system connected to sales information and a recipient; and

FIG. 5 depicts a database used in the cash flow management system of FIG. 4.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

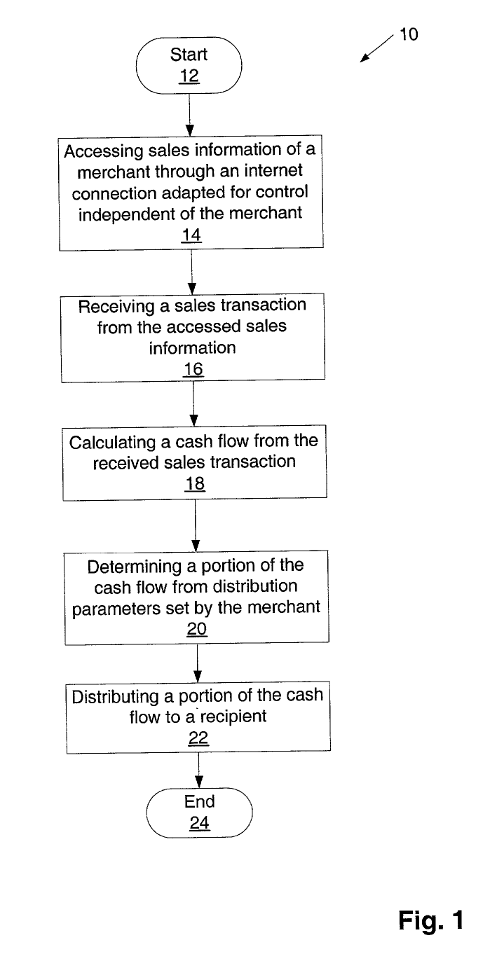

Turning to the drawings, FIG. 1 depicts a flowchart illustrating a method for managing a cash flow stream. In particular, method 10 of FIG. 1 depicts a manner in which to manage a merchant's flow of income. A merchant may refer to any individual or entity offering a product for sale. A product offered for sale by a merchant may include a variety of items. For example, a product for sale may include a good, such as merchandise, food, or any tangible object. Alternatively or in addition, the product may include a service, such as installation or repair work. Furthermore, the product may include entertainment, such as a musical concert or a theatrical performance. Generally, a merchant's stream of income is generated from the sale of such products. Other sources of income such as investments interests or donations, however, may be included in a merchant's cash flow stream.

Method 10 begins with starting step 12 leading to accessing step 14, which involves accessing sales information of a merchant through an Internet connection. Preferably, the Internet connection is adapted such that accessing the sales information may be performed independent of the merchant. In this manner, the Internet connection may be adapted to allow a user who is separate from the merchant to access sales information of the merchant. In some embodiments, the Internet connection may be adapted to enable the merchant, in addition to the independent user, to access their sales information. The sales information of the merchant may include systems used to sell and/or track product sales of the merchant. In a preferred embodiment, the merchant may have control over one or more of such systems. In other words, the merchant may have the authority to govern the accessibility and layout of one or more systems used to sell his or her own products, including that of which is used to track the sales of such products. For example, a merchant may establish a system, such as an Internet website, with which to sell products. In such an embodiment, the merchant may have control of, for example, the display, pricing, and distribution of such products. In another example, a merchant may establish an inventory control system in which to monitor product sales. Such an inventory system may be controlled the merchant.

Cash flow management method 10 of FIG. 1 may also include receiving step 16 which includes receiving a sales transaction from the sales information accessed through the Internet connection of step 14. The sales transaction may be obtained from a sale of a product sold by the merchant. In one embodiment, receiving step 14 may include downloading the sales transaction from an Internet store maintained by the merchant. An “Internet store” may be referred to as any Internet display from which products are offered for sale. In one embodiment, the Internet store may be part of a “host” website, i.e. a website that offers a plurality of Internet stores within one website. Alternatively, the Internet store may be a website by itself. In either embodiment, the Internet store may offer means to complete a sales transaction. In an alternative embodiment, receiving step 16 may include receiving a sales transaction from an inventory control system. In such an embodiment, accessing step 14 may be adapted to track the inventory control system for sales transactions. Tracking the inventory system may include auditing the receipt and dispatch of items listed in the inventory system over a specific period of time, thereby indicating when a sales transaction has been conducted. Tracking such a system may be conducted continuously or periodically.

Calculating step 18 may follow by calculating a cash flow from the received sales transaction of receiving step 16. The method may further include determining step 20, which involves computing a portion of the cash flow calculated in step 18 to be distributed to a recipient. The determination of such a portion may be governed by distribution criterion set by the merchant. The distribution criterion may include guidelines by which a merchant has decided to share a portion of his or her cash flow with a recipient. The distribution criterion may include fixed figures or varying criteria. For example, the distribution criterion may include a fixed percentage. In another embodiment, the distribution criterion may include varying percentages. In such an embodiment, the distribution criterion may be set such that the percentage used to calculate the portion of the cash flow distributed to the recipient fluctuates with respect to, for example, a specific time period, aggregate calculated cash flow, or the number of product units sold. In addition or alternatively, the distribution criterion may include fixed or varying monetary values. In such embodiments, the monetary values are preferably equal to or less than the total amount of the cash flow. As with the varying percentages, the varying monetary values may be based upon, for example, time, aggregate calculated cash flow, or the number of product units sold. In some embodiments, the distribution criteria may include portions of the total cash flow from which to calculate the portion to be distributed to the recipient.

The portion of the cash flow determined in step 20 of method 10 may be distributed via distributing step 22. More specifically, distributing step 22 may include distributing a portion of the cash flow calculated in calculating step 18 to a recipient. The recipient may include any individual or entity to which the merchant has authorized a portion of his or her cash flow to be distributed. For example, the recipient may be a contractor hired by the merchant to help the merchant market his or her product and/or run his or her business. In such embodiment, the contractor may be, for example, a printer, designer, or a parts supplier. In other embodiments, the recipient may be an employee of the merchant or an investor of the business. The recipient may also include individuals or entities which are not directly involved with the merchant's business. For example, the recipient may be a relative or friend of the merchant, a charitable organization, the merchant's bank account, or a debt collection agency. In some embodiments, the recipient may be the merchant.

In a preferred embodiment, distributing step 22 may include forwarding a portion of the cash flow from a user who accessed the sales information in step 14. In this manner, the user may forward the portion of the cash flow to the recipient without interaction of the merchant. Alternatively, the merchant may be involved in the distribution of the cash flow portion. In some embodiments, the distribution of the cash flow may be adapted such that the user may forward a portion of the cash flow to the merchant. The distribution of the portion of the cash flow in step 22 may be time-delayed relative to the time in which the portion of the cash flow is determined in step 20. For example, the distribution of the portion of the cash flow may be delayed beyond a time relative to which the cash flow is determined. Alternatively, the distribution of the portion of the cash flow may be substantially immediate relative to the time at which the portion of the cash flow is determined. In some embodiments, distributing step 22 may include transferring the portion of the cash flow determined in step 20 to the recipient electronically. Other distribution methods, such as check distribution or money wiring, may also be used in distributing step 22.

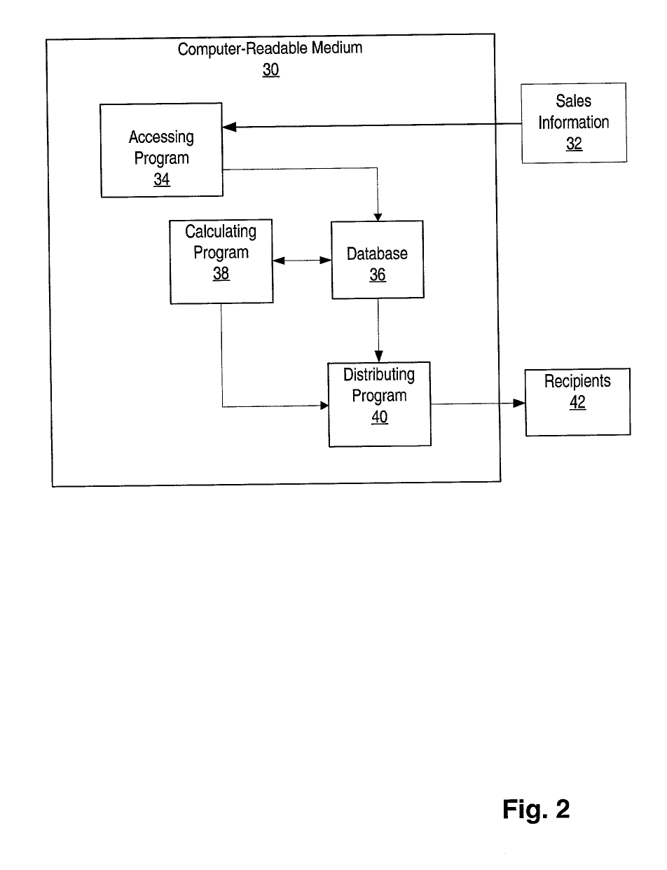

FIG. 2 illustrates a computer-readable medium, which may used to execute the method described in FIG. 1. In particular, computer-readable medium 30 is shown which may execute method 10. Such a computer-readable medium may include accessing program 34, which may be adapted to access sales information 32 through an Internet connection. In an embodiment, sales information 32 may be governed by the merchant. In addition, access program 34 is preferably adapted such that sales information 32 may be accessed independent of the merchant. In addition or alternatively, access program 34 may be adapted such that the merchant may access sales information 32. The computer-readable medium 30 may further include database 36 for receiving information about a sale from sales information 32. In addition, computer-readable medium 30 may include calculating program 38 to calculate a cash flow attributable to the sale. In one embodiment, calculating program 38 may be adapted to receive the information about the sale from database 36, and thus may connected to database 36 as illustrated in FIG. 2. Alternatively, calculating program 38 may be adapted to receive the information about the sale from accessing program 34, and thus may be connected to accessing program 34. In addition, calculating program may be adapted to transmit the calculated cash flow to database 36 as indicated by the double-arrowed connection between database 36 and calculating program 38 in FIG. 2.

Furthermore, computer-readable medium 30 may include distributing program 40 in connection with database 36 and/or calculating program 38. Distributing program 40 may be used to distribute a payment to recipient 42. Recipient 42 may include any of the recipients referred to in method 10 of FIG. 1. As such, recipient 42 may include any individual or entity to which the merchant has authorized a portion of his or her cash flow to be distributed. Distribution program 40 may be adapted to distribute a payment by any of the distribution methods described for distributing step 22 of FIG. 1. As such, distribution program 40 may be adapted to send the payment electronically, by check, or through money wiring. Distribution program 40 may include inputs or distribution guidelines outlining how the payment distributed to recipient 42 should be determined. The inputs may, alternatively, be included in database 36 and calculating program 38 may be used to compute the payment amount based on the calculated cash flow. As such, calculating program 38 may be adapted to forward the payments to database 36. In either embodiment, the distribution guidelines may be set by the merchant.

Preferably, the payment distributed to recipient 42 corresponds to at least a portion of the cash flow calculated by calculating program 38. For example, the portion of the cash flow may be a percentage of the cash flow. The percentage may be a fixed percentage or a variable percentage depending on inputs to distributing program 40. In another embodiment, the payment corresponding to a portion of the cash flow may be a fixed amount. In such an embodiment, distribution program 40 may be adapted to insure that the fixed amount does not exceed the total cash flow calculated in calculating program 38. In cases in which the fixed amount does exceed the total cash flow, the distribution program 40 may be adapted to distribute a notice that inadequate funds are available and that a payment will be not be distributed. Distribution program 40 may be further adapted to forward such a notice to the recipient and/or merchant. In addition, distribution program 40 and/or database 36 may be adapted to insure that the total of the distribution payments do not exceed the total cash flow calculated in calculating program 38. Likewise, distribution program 40 and/or database 36 may be adapted to insure that the sum of the distribution guidelines do not exceed 100% of the aggregate cash flow.

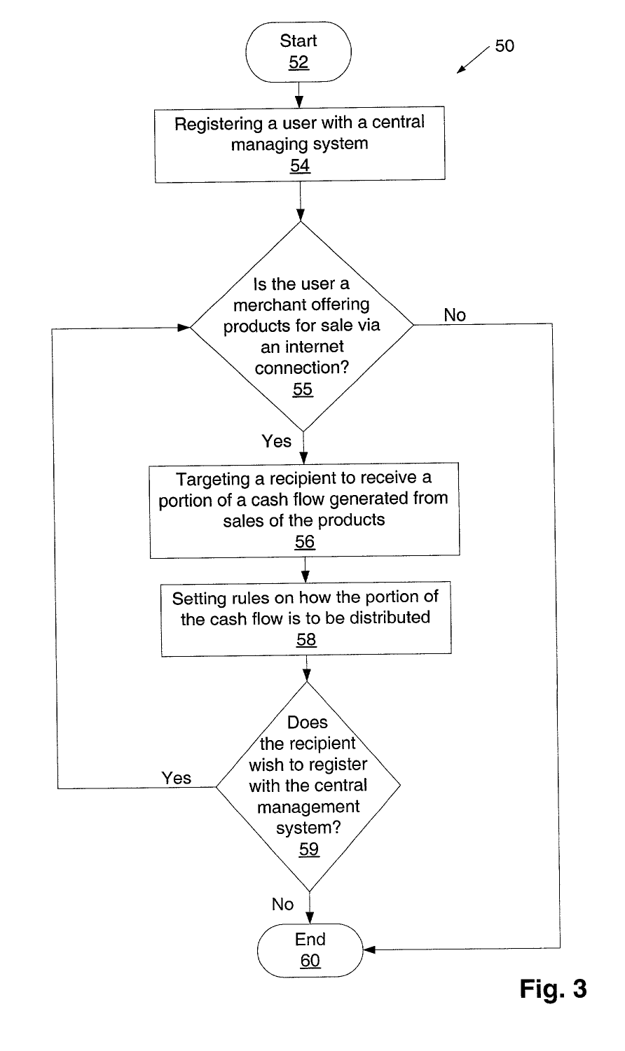

FIG. 3 illustrates an exemplary embodiment of method for creating a system as described herein. In particular, FIG. 3 depicts method 50 for creating a cash flow management system. Method 50 may begin at starting step 52 followed by registering step 54, which includes registering a user with a central managing system. Such a user may be a merchant or a recipient identified by the merchant. For example, registering may include identifying a system governed by a merchant which offers products for sale via an Internet connection. Moreover, registering may include establishing an Internet store with which to offer products for sale. In some embodiments, the registration process may include establishing an identity with the central management system. Such an identity may include a user name and password. Method 50 may further include step 55, which determines if the user is a merchant or a recipient. In the event that the user is a recipient, the method may terminate at step 60. Alternatively, if the user is a merchant, the method may continue to step 56 for targeting a recipient to receive a portion of a cash flow generated from sales of the user's products. Targeting a recipient may include searching for and selecting a recipient. Such a search and selection may be conducted by the user or an entity separate from the user, such as the central managing system. The recipient may include any of the recipients referred to in method 10 of FIG. 1. As such, the recipient may include any individual or entity to which the merchant has authorized a portion of his or her cash flow to be distributed.

Method 50 may further include step 58 which sets rules on how the portion of the cash flow is to be distributed. Preferably, the user has input to such rules. The rules may incorporated in a variety of manners. For example, step 58 may include designating a fixed monetary amount or a fixed percentage of the cash flow. Alternatively or in addition, step 58 may include designating varying percentages of the cash flow. In some embodiments, step 58 may include designating a respective qualifying variable for each payment variable. Examples of such qualifying variables may include a period of time, an aggregate cash flow amount, or the number of products sold by the user. In addition or alternatively, step 58 may include designating a segment of the cash flow from which to calculate the portion of the cash flow distributed to the recipient. Furthermore, step 58 may include negotiating the terms of the rules between the user and the recipient. As such, step 58 may include confirming the rules with the user and recipient. Such a confirmation may include a negotiation settlement agreement. Once the rules are set, method 50 may include step 59, which allows the recipient the option to register with the central managing system. Moreover, a recipient may register at any point within method 50.

In a preferred embodiment, the central management system may be adapted to receive the cash flow on behalf of the user. As such, the central management system may be further adapted, in some cases, to forward the portion of the cash flow to the recipient according to the distribution rules set in step 58. In some embodiments, the central management system may be adapted to delay forwarding the portion of the cash flow beyond a time relative to which the cash flow is received. In other words, the central management system may hold the portion of the cash flow for a period of time after the cash flow is received. Such an embodiment may be advantageous in order to account for fluctuations in the cash flow due to, for example, returns and/or chargebacks. Alternatively, the central management system may be adapted to immediately forward the portion of the cash flow relative to a time at which the cash flow is received.

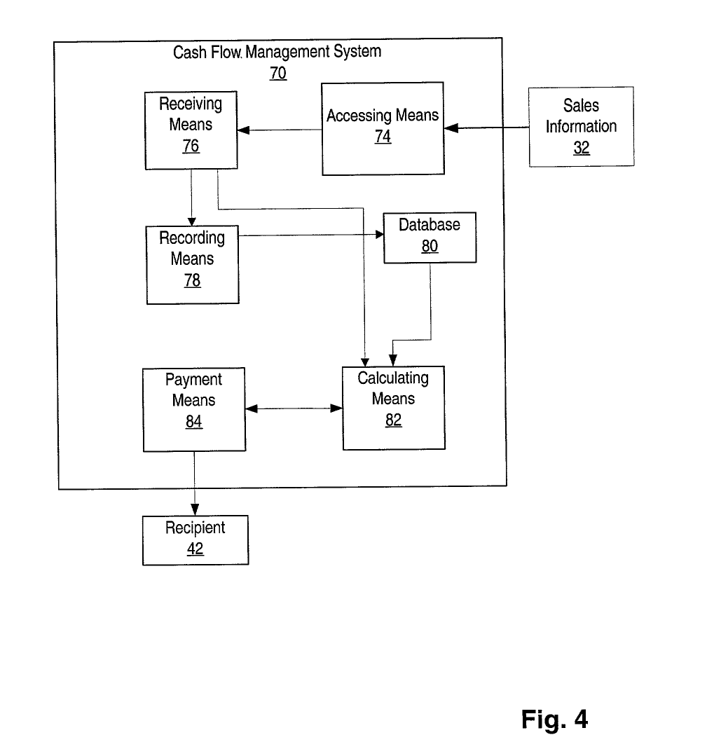

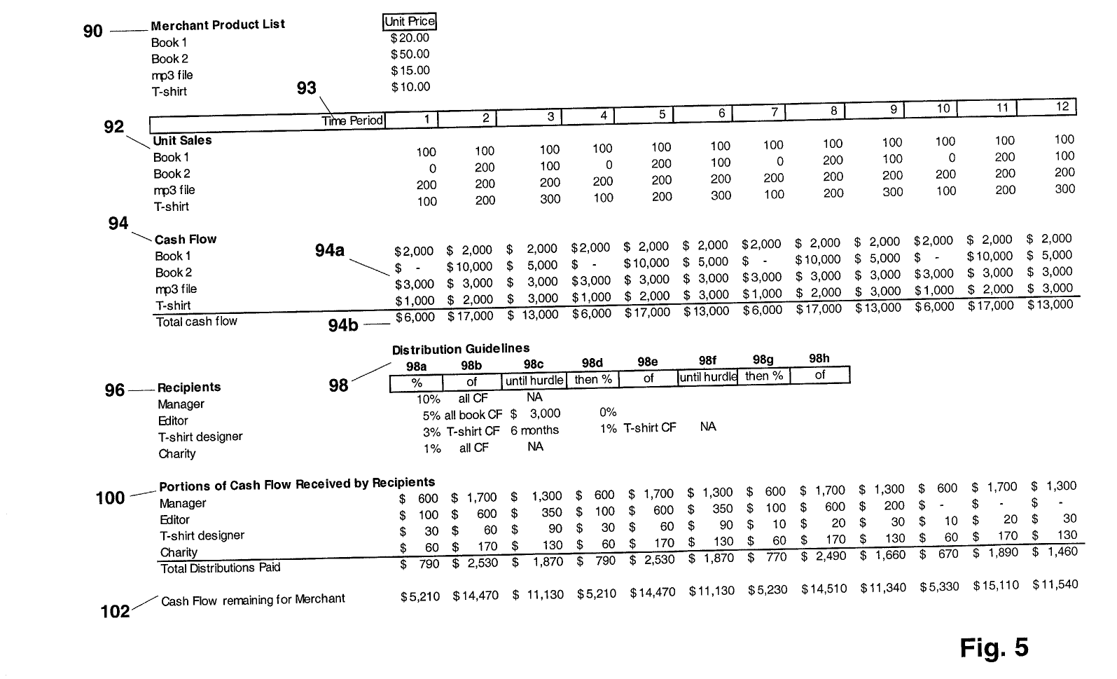

A cash flow management system as described herein is illustrated in FIG. 4. More specifically, cash flow management system 70 is shown in connection with sales information 32 and recipient 42. Sales information 32 and recipients 42 may be the same as described for computer-readable medium 30 of FIG. 2. Cash flow management system 70 may include accessing means 74 for accessing sales information 32 through an Internet connection. Access program 34 is preferably adapted such that sales information 32 may be accessed independent of the merchant. In addition or alternatively, access program 34 may be adapted such that the merchant may access sales information 32. System 70 may further include receiving means 76 to receive a sales transaction from sales information 32 and recording means 78 to record the sales transaction. Recording means 78 is preferably adapted to record the sales transaction in database 80. An exemplary embodiment of database 80 is illustrated and further described in FIG. 5 below. Cash flow management system 70 may also include calculating means 82 for computing a cash flow from the received sales transaction. The system may further include payment means 84 for paying a portion of the cash flow computed by calculating means 82.

Database 80 may be a database of one or more merchants. An exemplary embodiment of a file for an individual merchant included within database 80 is illustrated in FIG. 5. Database 80 may include product list 90 detailing the products offered for sale by the merchant with their respective unit price. Such products may include goods, services, or entertainment. In particular, goods may include physical products such as books, CD's, clothing, or works of art. In addition, good may include digital products such as mp3 files or e-books. For example, product list 90 in FIG. 5 includes 2 books each for $20 and $50, respectively. Product list 90 further includes an mp3 file for $15 and a t-shirt for $10. Database 80 may further include unit sales 92 outlining the number of products sold for period of time 93. Period of time 93 may vary. For example, time period 93 may be one or more days, weeks, months, or years. Alternatively, time period 93 may be substantially immediate upon the receipt of a sales transaction.

Database 80 may further include cash flow 94 computed from calculating means 82 of FIG. 4. Cash flow 94 includes cash flow segments 94a, which total the cash flow for a specific product. In addition, cash flow 94 may include aggregate cash flow 94b, which the total cash flow generated for time period 93. Database 80 may further include recipient list 96 and distribution guidelines 98 associated with each recipient. Distribution guidelines 98 may be classified into categories. For example, one category may include a payment variable which may specify a percentage or a fixed amount as illustrated in column 98a. A second category may specify the cash flow from which the distribution will be taken calculated. In particular, the second category may specify either aggregate cash flow 94b or one or more of cash flow segments 94a. For example, a guideline listed in column 98b of FIG. 5 is listed as “all CF” indicating that aggregate cash flow 94b is used for the calculation of the distribution payments to the manager and the charity. On the contrary, the guideline listed as “all book CF” for the editor recipient, may indicate that cash flow segments 94a for Book 1 and Book 2 are used for the calculation of the distribution payment to the editor.

Distribution guidelines 98 may also be governed by a third qualifier such as a period of time or a monetary amount as indicated by column 98c. Other qualifiers (not shown), such as the number of units sold, may also be used. Calculating means 82 of FIG. 4 may be adapted such that once a cash flow meets or exceeds the qualifier defined in column 98c, the entire payment portion may be calculated by guidelines specified in columns 98d and 98e instead of the guidelines specified in columns 98a and 98b. Alternatively, calculating means 82 of FIG. 4 may be adapted such that the payment portion may be calculated from categories 98a and 98b until the qualifier in category 98c is met and the remaining amount of payment portion may be calculated by categories 98d and 98e. An entry of “NA” may be used in the qualifying category to indicate that no qualifier is used. As such, payments to the t-shirt designer include 3% of all t-shirt proceeds for the first 6 months and then 1% of all t-shirt proceeds thereinafter. In some cases, the cash flow management system may be adapted such that a merchant may modify distribution guidelines 98 at any time. In a preferred embodiment, however, the cash flow management system may be adapted such that distribution guidelines 98 may be modified upon agreement of both the merchant and recipient.

Payments 100 may be calculated for each recipient based upon their corresponding distribution guidelines 98. As shown in FIG. 5, payments 100 may vary between time periods 93 since payments 100 are may be dependent upon cash flows 94. In addition, database 80 may include remaining cash flow 102 which outlines how much the merchant may have after sharing portions of the cash flow generated in time period 93. Database 80 may further include data from previous time periods as indicated in FIG. 5. Each column of data under time periods 93 indicates the sales, cash flow, and the distributions paid to recipients during a specific time period.

It will be appreciated to those skilled in the art having the benefit of this disclosure that this invention is believed to provide a method and a system for managing a cash flow stream. Further modifications and alternative embodiments of various aspects of the invention will be apparent to those skilled in the art in view of this description. For example, the systems and methods as described herein may be used by a variety of merchants. Furthermore, the systems may be adapted to manage multiple management streams. It is intended that the following claims be interpreted to embrace all such modifications and changes and, accordingly, the drawings and the specification are to be regarded in an illustrative rather than a restrictive sense.

What is claimed is:

1. A method for managing cash flow, comprising:
accessing sales information of a merchant through an Internet connection adapted for control independent of the merchant;
receiving a sales transaction from said sales information;
calculating a cash flow from said sales transaction; and
distributing a portion of the cash flow to a recipient.

2. The method of claim 1, wherein said accessing comprises accessing sales information through the Internet connection by a user separate from the merchant.

3. The method of claim 2, wherein said distributing comprises forwarding a portion of the cash flow to the recipient via the user.

4. The method of claim 1, wherein said accessing comprises accessing sales information through the Internet connection by the merchant.

5. The method of claim 1, wherein said receiving comprises downloading the sales transaction from an Internet store maintained by the merchant.

6. The method of claim 1, wherein said receiving comprises receiving the sales transaction from an inventory control system.

7. The method of claim 1, wherein said sales transaction is obtained from a sale of a product sold by the merchant.

8. The method of claim 7, wherein said product is selected from a group consisting of goods, services, and entertainment.

9. The method of claim 1, further comprising determining said portion of the cash flow from distribution guidelines set by the merchant.

10. A computer-readable medium, comprising:
a program for accessing a sales tracking device through an Internet connection, wherein the sales tracking device is governed by a merchant, and wherein the accessing program is adapted to be executed independent of the merchant;
a database for receiving information about a sale from said sales tracking device;
a program for calculating a cash flow attributable to said sale; and
a program for distributing a payment to a recipient, wherein the payment corresponds to at least a portion of the cash flow.

11. The computer-readable medium of claim 10, wherein said payment comprises a monetary or security interest.

12. The computer-readable medium of claim 10, wherein said distribution program is adapted to transfer said payment electronically.

13. The computer-readable medium of claim 10, wherein said portion of the cash flow is a percentage of the cash flow calculated by the distribution program, and wherein the percentage is a fixed or a variable amount dependent upon inputs to said distribution program.

14. A method for creating a cash flow management system, comprising:
registering a user with a central managing system, wherein the user offers products for sale via an Internet connection controlled by the user;
targeting a recipient to receive a portion of a cash flow generated from sales of said products; and
setting rules on how said portion of the cash flow is to be distributed to the recipient, wherein said setting rules comprises input from the user, wherein the central managing system is adapted to receive the cash flow on behalf of the user, and wherein the central managing system is further adapted to forward said portion of the cash flow to the recipient via the distribution rules.

15. The method of claim 14, wherein said central managing system is adapted to delay forwarding the portion of the cash flow beyond a time relative to which the cash flow is received.

16. The method of claim 14, wherein said central managing system is adapted to immediately forward the portion of the cash flow upon a time at which the cash flow is received.

17. The method of claim 14, wherein said setting rules comprises designating at least one payment variable.

18. The method of claim 17, wherein said payment variable is a percentage or a fixed monetary amount.

19. The method of claim 17, wherein said setting rules further comprises designating a respective qualifying variable for each payment variable.

20. The method of claim 17, wherein said qualifying variable is a period of time.

21. The method of claim 17, wherein said qualifying variable is an aggregate cash flow amount.

22. The method of claim 17, wherein said qualifying variable is a number of products sold by the user.

23. The method of claim 14, wherein said setting rules comprises designating a segment of the cash flow from which to calculate said portion of the cash flow.

24. A cash flow management system, comprising:
accessing means for accessing sales information of a merchant through an Internet connection, wherein said accessing means is adapted such that the sales information may be accessed independent of the merchant;
receiving means for receiving a sale from said sales information;
calculating means for computing a cash flow from said sale; and
payment means for paying a portion of said cash flow to a recipient.

25. The system of claim 24, further comprising:
a database; and
recording means for recording the sale in the database.

26. The system of claim 25, wherein said database comprises:
a list of products offered for sale by the merchant; and
a number of products sold for a specific period of time.

27. The system of claim 25, wherein said database comprises:
a list of recipients; and
distribution guidelines associated with each recipient.

28. The system of claim 27, wherein said calculating means is adapted to calculate said portion of the cash flow based on the distribution guidelines.
